(19) United States
(12) Patent Application Publication
(10) Pub. No.: US 2011/0231208 A1
(43) Pub. Date: Sep. 22, 2011

(54) SYSTEM AND METHOD FOR PATIENT SELF-ASSESSMENT OR TREATMENT COMPLIANCE

(75) Inventor: Adam Ian Kaplin, Baltimore, MD (US)

(73) Assignee: The Johns Hopkins University, Baltimore, MD (US)

(21) Appl. No.: 13/130,739

(22) PCT Filed: Dec. 17, 2009
(86) PCT No.: PCT/US2009/068538

§ 371 Date: May 23, 2011

Related U.S. Application Data
(60) Provisional application No. 61/138,346, filed on Dec. 17, 2008.

(51) Int. Cl. G06Q 50/00; G06F 15/16; G06Q 10/00

(52) U.S. Cl. 705/3; 709/206

(57) ABSTRACT

A system and method for transmission of alphanumeric messaging between mobile subscribers and an external system to send messages directly to the mobile subscriber's existing mobile phone to query them, for example, on the psychometric scale of interest. The resulting daily assessments may then be stored in a database that may be accessed via the interne to aid both the patient and a care provider in tracking the state and progress of the illness or symptoms which are being treated. It may allow the database to be queried to display trends over varying time intervals at any time in the past. The system and method may also provide for automatically notifying care providers if the patient is acutely having severe symptoms for a redefined duration and severity, and may facilitate a way to increase patient compliance with monitoring.

### CROSS-REFERENCE TO RELATED APPLICATION

This application claims priority to U.S. Provisional Application No. 61/138,346 filed Dec. 17, 2008, the entire content of which is hereby incorporated by reference.

### BACKGROUND

1. Field of Invention

The current invention relates to automated systems utilizing electronic sampling, and more particularly to automated systems to ascertain, organize and monitor a patient's self-assessment of various subjective mental phenomena or treatment compliance.

2. Discussion of Related Art

One of the most efficacious ways of following the course of a patient's mental phenomenon, such as mood (e.g., depression or mania), pain or anxiety, for either diagnostic or treatment purposes is to ask them to keep a daily log of the course of this dimension. For example, visual analog scales (e.g., a line from happy to sad) and numeric rating scales (1-10) are the standard clinical tools used to track subjective patient assessments of their mental phenomenon such as mood (e.g., depression or mania), pain or anxiety. And when patients come to see their physicians, it is almost impossible to follow the impact of various treatments (e.g., medications, physical therapy, etc.) over the course of days let alone months or years without a daily diary of these parameters. The difficulty is motivating patients to record their daily assessments of these states and to bring the scales in to their healthcare appointments. So, for example, when patients are depressed or suffer from severe pain syndromes, compliance is a major struggle. Compliance with treatment recommendations is also difficult to ascertain and there is a dearth of systems to encourage increased patient compliance with tracking their subjective mental phenomenon as well as their treatment compliance.

Therefore, there remains a need for a system and method that automatically records and tracks psychometric data obtained from patients.

### SUMMARY

One embodiment of a method for patient self-assessment or treatment compliance may include inputting into a storage device patient contact information, transmitting by a communication device an electronic message based on the contact information, receiving by the communication device a plurality of responses, storing the plurality of responses into the storage device, storing the time and date of receipt for each of the plurality of responses into the storage device, and querying the storage device for trends based on the plurality of responses.

Another embodiment may include a computer readable medium storing executable instructions for execution by a computer having memory, where medium stores instructions for inputting contact information into a data storage device, transmitting an electronic message based on the contact information, receiving a response, storing the response and a timestamp into the data storage device, storing a time and date of receipt of the response into the data storage device, and querying the database for trends based on the response.

In yet another embodiment, a patient monitoring system may include a data storage device, a messaging system coupled to the data storage device, and a central processing unit (CPU) having memory storing CPU-executable instructions for assisting with a psychometric assessment of a patient, wherein the CPU may be coupled to the messaging system and to the data storage device. According to an embodiment, the CPU may perform the following according to the CPU-executable instructions of storing a patient contact information in the data storage device, transmitting an electronic message based on the contact information, receiving a response, storing the response in the data storage device, and storing a time and date of receipt of the response into the data storage device.

### BRIEF DESCRIPTION OF THE DRAWINGS

The invention may be better understood by reading the following detailed description with reference to the accompanying figures, in which:

FIG. 1 is an illustrative embodiment of a Global Systems for Mobile Communications (GSM) sample telecommunications network;

FIG. 2 depicts an example high-level view of an illustrative embodiment of a message storage and distribution system according to an illustrative embodiment of the present invention.

FIG. 3 is an illustrative embodiment of a sample graph showing the severity of a symptom for a patient over a period of time on a scale from 0-10;

FIG. 4 is an illustrative embodiment of stored data;

FIG. 5 depicts an example computer system that may be used in implementing an illustrative embodiment of the present invention; and

FIG. 6 is an illustrative embodiment depicting message flow.

### DETAILED DESCRIPTION

In describing embodiments of the present invention illustrated in the drawings, specific terminology is employed for the sake of clarity. However, the invention is not intended to be limited to the specific terminology so selected. It is to be understood that each specific element includes all technical equivalents which operate in a similar manner to accomplish a similar purpose.

Psychometric Assessment Gained by Electronic Sampling (PAGES), is a technology to ascertain, organize and monitor patient's self-assessment of various subjective mental phenomena and compliance with treatment regimens according to some embodiments of the current invention.

In one embodiment, the method and system monitors a patient's mental phenomenon, such as mood (e.g., depression or mania), pain or anxiety, for either diagnostic or treatment purposes. The method may involve contacting the patient using, for example, a wireless service that sends a message to their mobile device. The patient may then self-assess their mood, pain or anxiety and may then respond via their mobile device on, for example, the psychometric scale of interest. The resulting daily assessments may be transmitted back to an originating service provider computer/server/communication device and stored in a data storage device such as a database. The data may be accessed in a secure fashion via, for example, the internet to aid both the patient and their care provider in tracking the state and progress of the illness or symptoms which are being treated. It may allow the data storage device to be queried to display trends over varying time intervals (e.g., days, weeks, months, years) at any time in the past. Additionally, an embodiment may provide a mechanism to automatically notify care providers, family members, emergency personnel, etc. if the patient does not respond or the response triggers a threshold value. For example, if the patient has acute and severe symptoms for a predefined duration and severity person designated by the patient (such as a health care provider, family member, friend and/or emergency personnel) can be notified.

Further, an embodiment may facilitate a mechanism to increase patient compliance with the monitoring, and to organize and document care providers treatment recommendations and prescriptions. Another embodiment of the invention may allow for the assessment of compliance with a pharmaceutical regimen, such as that required during clinical trials or after surgery.

### An Example Telecommunications Network—GSM Network

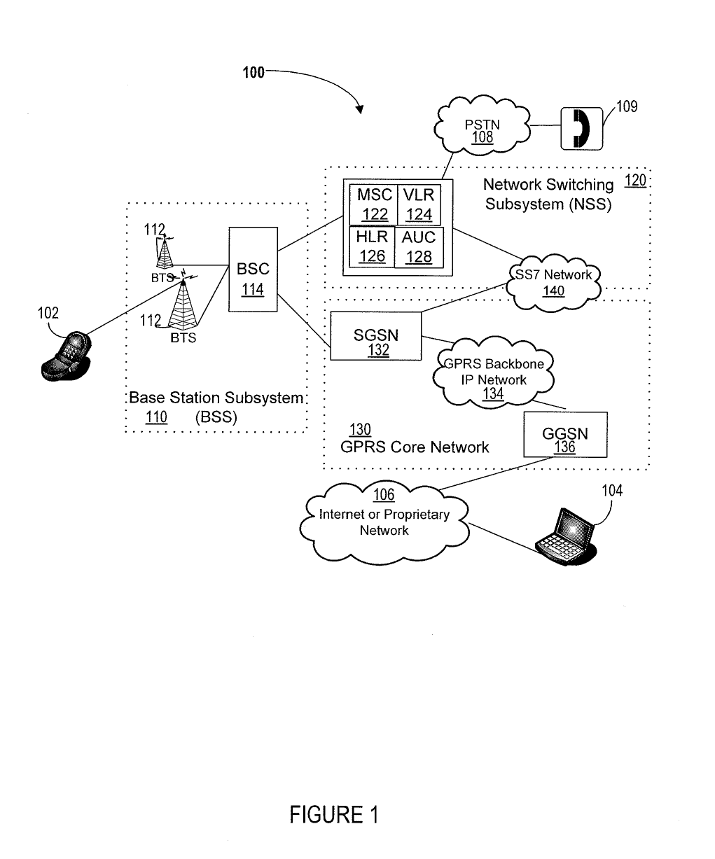

FIG. 1 is a block diagram providing an overview of a standard Global Systems for Mobile Communications (GSM) telecommunications network 100 providing mobile communication services for a mobile device 102, for example. Mobile devices may include, but are not limited to, a mobile phone, a personal digital assistant (PDA), a netbook, a laptop, a BLACKBERRY®, an IPHONE®, or other communication device.

The GSM Network supports the transmission of Short Message Service and GSM is used only as an example network. Other mobile technologies support SMS, such as, but not limited to, ANSI CDMA networks and Digital AMPS, as well as satellite and landline networks. Many other non-GSM network systems support an equivalent messaging system.

A mobile device 102 may wirelessly transmit data and voice information with the base station subsystem (BSS) 110. The BSS may be responsible for handling traffic and signaling between a mobile device 102 and a network switching subsystem NSS 120. The BSS contains components such as the base transceiver station (BTS) 112 and the base station controller (BSC) 114. The BTS 112 contains equipment for receiving and transmitting electromagnetic radiation, including, antennas, transceivers, and encryption/decryption devices. The BSC 114 may control hundreds of BTSs and allocate radio channels and handle handovers of a mobile device from one BTS 112 to another. The BSS 110 may contain other components such as a transcoder (not shown) and a packet control unit (PCU) (not shown).

The General Packet Radio System (GPRS) may be used by mobile devices using GSM. The GPRS Core Network (GCN) 130 may be an integrated part of the GSM network 100. The GCN may contain components such as the Serving GPRS Support Node (SGSN) 132, the GPRS Network Backbone 134, and the Gateway GPRS Support Node (GGSN) 136. The SGSN 132 may deliver data packets to and from BSSs 110 within its geographical area. The GPRS Network Backbone 134, may be an IP based network that carries the subscriber's data from one location at the current SGSN 132 to the GGSN 136 which is handling the subscriber's session. The GGSN 136 is responsible for connecting the GPRS network 134 with external networks, such as the Internet or a proprietary network 106. A device 104 connected with the Internet or proprietary network 106 may communicate through the GCN 130 and GSM networks (or similar network not shown) with mobile device 102.

The Network Switching Subsystem (NSS) 120 is also a major component of the GSM network and facilitates communications between mobile devices 102 and the Public Switched Telephone Network (PSTN) 108 as well as switching functions. The NSS 120 may contain components such as a Mobile Switching Center (MSC) 122, a Visitor Location Register (VLR) 124, a Home Location Register (HLR) 126, an Authentication Center (AUC) 128. The MSC 122 may handle voice calls, SMS, conference calls, FAX data, circuit data and other services. The VLR 124 may determine the location of mobile devices. The HLR 126 may be a central data repository that contains details of every subscriber authorized to use the network 100. The AUC 128 may facilitate the authentication of mobile devices 102 that attempt to connect to the GSM network 100.

The PSTN facilities 108 associated with telecommunications network 100 include an access tandem (AT) (not shown) at points of presence (POPs) (not shown) that can provide access to, for example, one or more inter-exchange carriers (IXCs) (not shown) for long distance traffic. Network 100 may also include a common channel interactive signaling (CCIS) network for call setup and call tear down such as a Signaling System 7 (SS7) signaling network 140.

The network 100 may also have a Short Message Service Center (not shown) or equivalent functionality that receives a message (typically text), stores the message, and forwards the message to the appropriate recipient or recipients.

### Patient Monitoring

In one embodiment, a network, such as depicted in FIG. 1, may facilitate the transmission of communications between individuals. Such communication could include alphanumeric messaging such as SMS. Network subscribers may use mobile devices 102, 280A, 280B to connect to the network and may send voice and/or data traffic to a service provider communication and/or computing device 210.

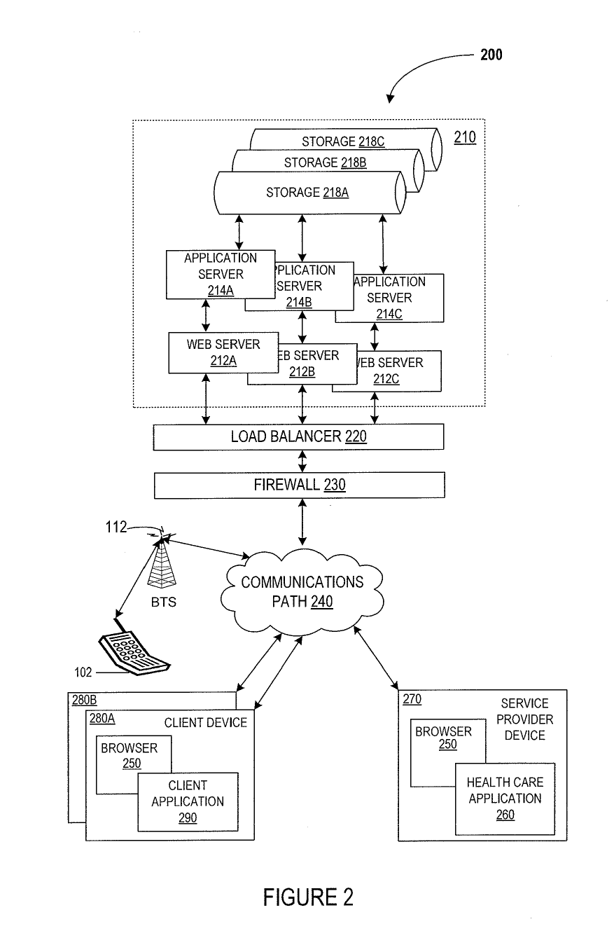

In one embodiment, FIG. 2 depicts an example high-level view of an illustrative embodiment of a message storage and distribution system 200 according to an illustrative embodiment of the present invention. Patient devices 102, 280A, 280B may be used by a patient to receive and respond to communications from a service provider. The service provider communication or computing device 210 may send and receive communications to a patient's mobile device 102, 280A, 280B, or other patient communication device. Such communication could be used to query them on the psychometric scale of interest, to monitor a patient's progress, to ensure compliance with a treatment regime, course of treatment, or prescribed medications.

An illustrative embodiment of a service provider communication and/or computing device 210 may provide for a client-server network design with back-end services and processing and may include one or more web servers 212A, 212B, 212C, etc. (collectively 212), one or more application servers 214A, 214B, and 214C, etc. (collectively 214) and may have a physical or logical storage unit 218A, 218B, and 218C, etc. (collectively 218). A single web server 212 may directly communicate with any of the application servers 214.

The responses from the patient device 102, 280A, 280B may include daily assessments, may be saved or stored in a data base or storage device 218 that may be securely accessed either through the Internet or other network 240. The stored information may be used by both the patient and the service provider in tracking the state and progress of the treatment, illness, or symptoms which are being treated.

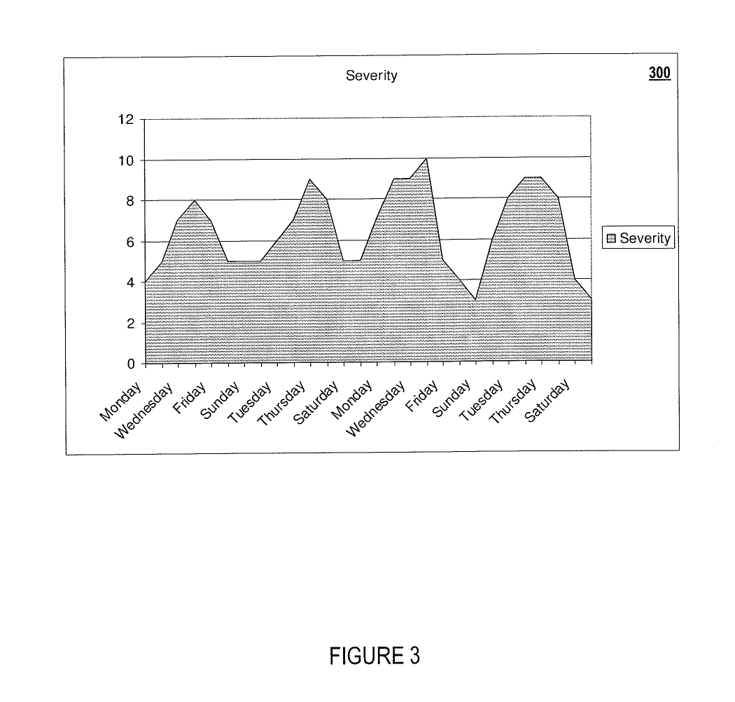

Data stored in data storage device 218 may be queried to display trends over a period of time, such as hours, days, weeks, months, or years (for example, see FIG. 3, 300). The system 200 may also provide a mechanism to automatically notify a person designated by the patient (such as health care providers, medical or emergency personnel, family members, or other appropriate personnel) if the received patient communication triggers a specified duration and/or severity threshold (e.g., for example, the patient may acutely have severe symptoms for a predefined duration and severity). The system 200 also facilitates an increase in patient compliance with the monitoring, and to organize and document care provider treatment, recommendations, prescriptions, or other health care regimes.

In one embodiment, the embodiment would lend itself to care providers having a facile system to generate and keep track of treatment recommendations, including generating electronic prescriptions and patient handouts, which may integrate into a storage device 218 that correlates these recommendations with the psychometric data obtained from the patient's reporting via electronic sampling (e.g. SMS). Such sampling may be sent from the service provider communication and/or computing device 210.

The ability to monitor patients', for example, mental phenomena, via querying and receiving short messages from the patient device 102, 280A, 280B (e.g., mobile handsets, mobile devices, etc.) can be applied to a diverse array of subjective symptoms, including but not limited to, mood, anxiety, pain, sleep, compliance with treatment, etc. For example, in the case of tracking a patients' mood as a component of a monitoring and treatment plan, the following paragraphs illustrate some of the steps that could be employed in the process.

In one embodiment, a patient seeking treatment for depression, for example, may work with a service provider to input contact information for the patient's device 102, 280A, 280B (e.g., mobile device) into a secure data repository 218 (e.g., for example, but not limited to, a secure website) which may then employ a messaging technology (e.g., but not limited to, SMS) to transmit, for example, a daily query to the patient requesting information. This request for information could, for example, state: “On a scale of 0-10 how is your depression today?”

The patient or recipient of the message may respond simply with a single number or letter (e.g., texting back a number). This response may be stored in a data repository 218 (e.g., database) as a data point linked to the patient's identity (e.g., a code associated with the patient) and the date and time of their response. One embodiment may also include patient location information.

The service provider communication and/or computing device 210 may create, store, transmit, and receive electronic transmissions. The service provider device 210 may allow for storage of multiple service provider requests and the patient transmissions. The service provider communication and/or computing device 210 may also allow for requests for a query of information. The physical or logical storage unit 218 may, for example, store sample queries, reply from patients, service provider requests, instructional text or video, photographs, audio, text, marketing information, product information, and client data. The servers 212 and 214 may be coupled to client devices 102, 280A, 280B and service provider device 270 through a communications path 240 (e.g., but not limited to, the Internet) via a load balancer 220 and a firewall 230. According to another embodiment (not shown), the distribution system 200 could be represented by any of a number of well known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) could also be used.

According to one embodiment, a service provider device 270 may provide hardware and software tools for a service provider (not shown) to provide information and content such as, e.g., but not limited to, queries, patient assessment requests, patient responses, informational videos, audio, photographs, textual description, product information, patient instructions, etc, to the system 200 which may be stored in a storage unit 218.

The service provider device 270 may be a computing device 500 or any other device capable of interacting with a network such as the communications path 240. The service provider device 270 may contain a health care application 260 which may provide a service provider (not shown) the ability to, e.g., access, add, delete, modify, and create content. The content creation application may be proprietary, commercial, or open source software or a combination. The content creation device may also provide the ability to program the service provider communication and/or computing device 210 to respond intelligently to received communications from the patient communication device 102, 280A, 280B. For example, a certain transmission from the patient communication device 102, 280A, 280B received by the service provider communication and/or computing device 210 may trigger the service provider communication and/or computing device 210 to send a communication to the patient communication device, the service provider device 270, to patient family members, to emergency personnel, etc.

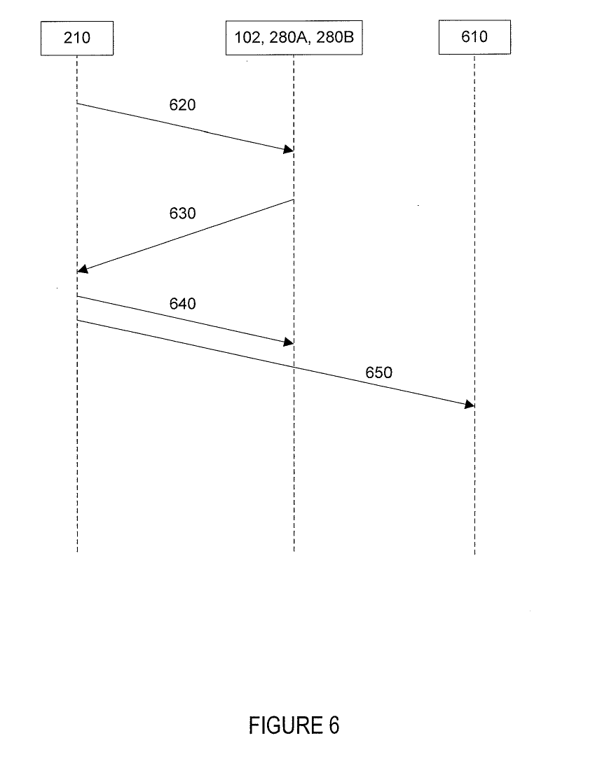

FIG. 6 depicts a sample embodiment of communication between the service provider communication and/or computing device 210 the patient communication device 102, 280A, 280B, and people designated by the patient (such as health care professionals, emergency personnel, or family members) 610. A communication 620 may be transmitted from 210 and may represent a patient question. The communication 620 is transmitted to the patient communication device 102, 280A, 280B. The patient may respond by transmitting a response 630 to the service provider communication and/or computing device 210. The service provider communication and/or computing device 210 may receive transmission 630 and may store the communication in data storage 218. The service provider communication and/or computing device 210 may also intelligently respond to the patient by sending a communication 640 to the patient communication device 102, 280A, 280B. Also, based on the response 630, the service provider communication and/or computing device 210 may intelligently report the response by transmitting a message 650 to people designated by the patient (such as health care professionals, emergency personnel, friends or family members) 610.

In the embodiment depicted in FIG. 2, the service provider device 270 may also contain a browser 250 (e.g., but not limited to, Internet Explorer, Firefox, Opera, etc.), which may, in conjunction with web server 212, allow a service provider (not shown) the same functionality as the health care application 260. As recognized by one skilled in the art, several service provider devices 270 may exist in system 200. Health care application may provide a health care professional with the ability to query the service provider communication and/or computing device 210 to produce a report based on the data collected.

The patient and individuals designated by the patient may have access to the data repository 218 and may graphically view the quantified magnitude and course of the patient's symptoms (e.g., depression) that can be viewed over a flexible set of time scales (e.g., hours, days, weeks, months, years) with any point in time of interest (e.g., with a designated beginning and ending of the data set of interest). That way the patient's response to treatment, for example, can be monitored and treatment decisions made accordingly.

FIG. 3, 300 depicts an illustrative embodiment of a sample graphical chart. In 300, the severity of a patient's depression, for example, is charted over the course of two weeks. Exemplary graphs may contain much more detailed information, such as date, time, prescriptions currently taken, current treatment, etc. Such charts may provide patients and people designated by the patients an easy method to view and track the patient's treatment progression.

If the patient's responses to the information requests meet a user-defined set of criteria that are worrisome to the patient's clinical condition (e.g., a depression score of 10 for 4 days in a row) then the system may respond by generating an email notification that may be sent to the patient's care provider, emergency personnel, family members, etc. to alert the necessary personnel to the gravity of the patient's clinical condition. This could, for example, prevent suicides by alerting care providers to the times their patient's mood disorder is acutely worse and allow appropriate personnel to provide the patient with additional support.

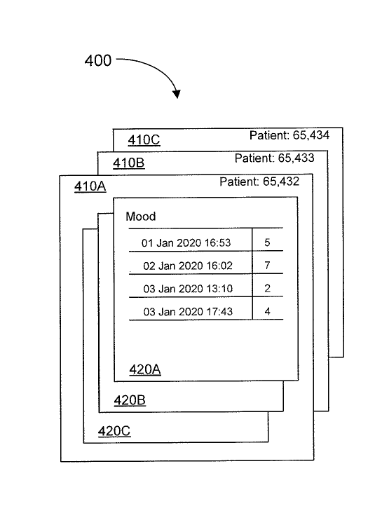

FIG. 4, 400, depicts sample relational database entries that may exist in one embodiment in data repository 218. 410A may depict multiple data entries for patient 65,432. 410B-410C may illustrate data for additional patients. 420A may depict a table within patient 65,432 and represents data collected on the patient's mood. 420A depicts, for example, time and date of patient's response and the actual response data. 420B-420C may represent additional data collections (e.g., anxiety, pain, sleep, compliance with treatment, etc.).

In the embodiment depicted in FIG. 2, multiple client devices 102, 280A, 280B, etc., may exist in system 200. Client device 102, 280A, 280B may be a computing device 500 or any other device capable of interacting with a network such as the communications path 240. Client device 102, 280A, 280B may contain a client application 290. Client application 290 may be proprietary, commercial, or open source software or a combination. Client device 280 may also contain a browser 250 which may, in conjunction with web server 212, allow a user, client, or customer the same functionality as the client application 290.

System 200 also contains a communications path 240. Communications path 240 may include, e.g., but not limited to, a network, a wireless or wired network, the internet, a wide area network (WAN), or a local area network (LAN). The communications path may provide a communication medium for the content creation device 270, the client devices 102, 280A, 280B, and one or more servers 212 and 214 through a firewall 230.

In one illustrative embodiment, storage device 218 may include a storage cluster, which may include distributed systems technology that may harness the throughput of, e.g., but not limited to, hundreds of CPUs and storage of, e.g., but not limited to, thousands of disk drives. As shown in illustrative FIG. 2, message and file upload and download operations may be provided via one or more load balancing devices 220. In one exemplary embodiment, the load balancer 220 may include a layer four (“L4”) switch. In general, L4 switches are capable of effectively prioritizing TCP and UDP traffic. In addition, L4 switches, which incorporate load balancing capabilities, may distribute requests for HTTP sessions among a number of resources, such as web servers 212. For this exemplary embodiment, the load balancer 220 may distribute upload and download requests to one of a plurality of web servers 212 based on availability. The load balancing capability in an L4 switch may be currently commercially available.

In one embodiment, the storage device 218 may communicate with web servers 214 and browsers 250 on remote devices 102, 280A, 280B and 270 via the standard Internet hypertext transfer protocol (“HTTP”) and universal resource locators (“URLs”). Although the use of HTTP may be described herein, any well known transport protocol (e.g., but not limited to, FTP, UDP, SSH, SIP, SOAP, IRC, SMTP, GTP, etc.) may be used without deviating from the spirit or scope of the invention. The client devices 280 and content creation device 270, the end-user, may generate hyper text transfer protocol (“HTTP”) requests to the web servers 212 to obtain hyper text mark-up language (“HTML”) files. In addition, to obtain large data objects associated with those text files, the end-user, through end user computer devices 270 and 280, may generate HTTP requests (via browser 250 or applications 260 or 290) to the storage service device 218. For example, the end-user may download from the servers 212 and/or 214 content such as, e.g., but not limited to, customized instructional videos. Servers 212 and/or 214 may also push content to devices 102, 280A, 280B, 270. In one embodiment, when the user “clicks” to select a given URL, the content may be downloaded from the storage device 218 to the end-user device 102, 280A, 280B or 270, for interactive access via browser 250, and/or application 260 and/or 290, using an HTTP request generated by the browser 250 or applications 260 or 290 to the storage service device 218, and the storage service device 218 may then download the content to the end-user computer device 270 and/or 280.

In one embodiment, the system hardware and software may enable physicians to generate prescriptions at the time of their contact with the patient by populating a form that may perform the following:

1) printing out an electronic prescription or set of specific instructions to give to the patient,

2) entering the medication name and amount into the database so that it can be viewed on a timeline with the patients depression, and

3) sending a copy of the electronic prescription directly to the patient's chosen pharmacy.

In one embodiment, charges for individual SMS messages and or use of the database may be assessed by the service that runs the Internet server and network that allows for the charting of the patient's depression and treatment decisions.

In one embodiment, where the patient requires monitoring of both, for example, depression and compliance with medication recommendations, the information requests may be given simultaneously or on alternative days to improve patient compliance with treatment.

In another embodiment, psychometric or quantifiable subjective assessments using this technology may include, but are not limited to, mental phenomena (e.g., depression, mania, anxiety, pain, sleep quality and quantity, sexual function, dizziness, weakness, concentration, memory, appetite, number of daily calories, bowel or bladder function, exercise capacity or quantity, or other mental phenomenon that can be reflected upon by patients and can serve as target symptoms as part of a treatment plan, etc.). Patient compliance with their medication regimen may also be queried and recorded.

Messages may be sent at varying times and time intervals (e.g., hourly, daily, every other day, weekly, multiple times a day, at specific times such as AM or PM, monthly, yearly, etc.). Multiple messages may be sent at alternating time. Patients could choose to respond via email or other communication if SMS messaging was not preferable or available. The ability to alert the physician as well as patient's caregivers if predefined thresholds in responses were met that signaled concern about the patient's status may be included (e.g., both the doctor and the patient's family could receive emails or SMS messages if, for example, the patient's depression was 10/10 for 4 or more consecutive days). The ability to integrate into the storage repository or database of the patient's psychometric assessments the advice given by the patient's physician (e.g., medication dose increase or decrease, dietary changes, exercise regimens, etc.) could be used as part of the technology that is tracked along with the mental phenomenon. Electronic prescriptions that are given directly the patient and or sent to the patient's designated pharmacy can also be integrated, as can the patient's monitoring labs (e.g., drug levels from serum measurements, etc.).

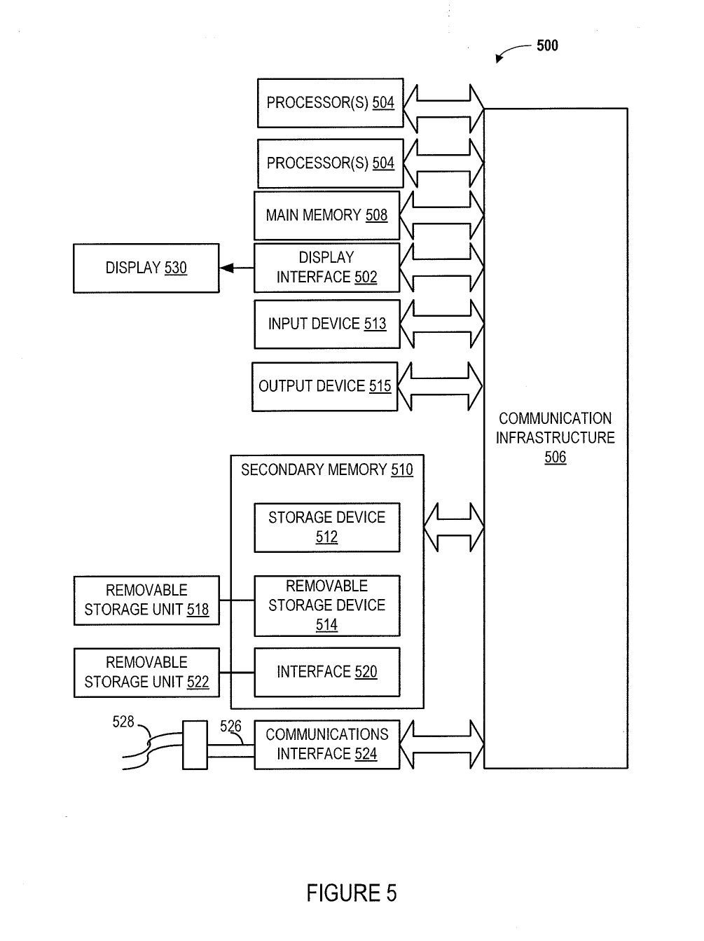

FIG. 5 depicts an illustrative embodiment of a computer system 500 that may be used in computing devices such as, e.g., but not limited to, client or server devices. FIG. 5 depicts an illustrative embodiment of a computer system that may be used as client device, or a server device, as part of an online multicomputer system, a standalone device or subcomponent, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 500 may be shown in FIG. 5, depicting an illustrative embodiment of a block diagram of an illustrative computer system useful for implementing the present invention. Specifically, FIG. 5 illustrates an example computer 500, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. However, the invention may not be limited to these platforms. Instead, the invention may be implemented on any appropriate computer system running any appropriate operating system. In one illustrative embodiment, the present invention may be implemented on a computer system operating as discussed herein. An illustrative computer system, computer 500 may be shown in FIG. 5.

Other components of the invention, such as, e.g., (but not limited to) a computing device, a communications device, a telephone, a personal digital assistant (PDA), a personal computer (PC), a handheld PC, a laptop computer, a netbook, a video disk player, client workstations, thin clients, thick clients, a mobile device, a mobile phone, proxy servers, network communication servers, remote access devices, client computers, server computers, routers, web servers, data, media, audio, video, telephony or streaming technology servers, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various illustrative software embodiments may be described in terms of this illustrative computer system. After reading this description, it may become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, DVD, BlueRay, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, magneto-optical device, compact disk, a digital versatile disk, a high definition video disk, a BlueRay disk, etc. which may be read from and written to by removable storage drive 514. As may be appreciated, the removable storage unit 518 may include a computer usable storage medium having stored therein computer software and/or data.

In alternative illustrative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, Flash memory device, SDRAM, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, touchscreen, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Other input devices may include a facial scanning device or a video source, such as, e.g., but not limited to, a web cam, a video camera, or other camera.

In this document, the terms “computer program medium” and “computer readable medium” may be used to generally refer to media such as, e.g., but not limited to, removable storage drive 514, and a hard disk installed in hard disk drive 512, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an illustrative embodiment,” do not necessarily refer to the same embodiment, although they may.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to this data as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another illustrative embodiment, the invention may be implemented using a combination of any of, e.g., but not limited to, hardware, firmware and software, etc.

### Communications Embodiments

In one or more embodiments, the present embodiments are practiced in the environment of a computer network or networks. The network may include a private network, or a public network (e.g., the Internet), or a combination of both. The network includes hardware, software, or a combination of both.

The network may be described as a set of nodes connected by a communications facility, with one or more processes (hardware, software, or a combination thereof) functioning at each such node. A single process may be run by multiple processors, or multiple processes may be run by a single processor. Communications between the nodes may be made possible by a communications network. A node may be connected either continuously or intermittently with communications network. Additionally, each of the nodes may provide an interface point between network and the outside world, and may incorporate a collection of sub-networks.

As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless e-mail devices including IPHONE™, and BLACKBERRY™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or a collection of networks.

The communications network may include wireline communications capability, wireless communications capability, or a combination of both, at any frequencies, using any type of standard, protocol or technology. In addition, in the present embodiments, the communications network can be a private network (for example, a VPN) or a public network (for example, the Internet).

A non-inclusive list of exemplary wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The embodiments may be employed across different generations of wireless devices. This includes 1G-4G, nG, etc., according to present paradigms.

While various embodiments of the present invention have been described above, it should be understood that they have been presented by way of example only, and not limitation. Thus, the breadth and scope of the present invention should not be limited by any of the above described exemplary embodiments, but should instead be defined only in accordance with the following claims and their equivalents. Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

We claim:

1. A method of patient monitoring comprising:
inputting into a storage device patient contact information;
transmitting by a communication device an electronic message based on the contact information;
receiving by the communication device a plurality of responses;
storing the plurality of responses into the storage device;
storing the time and date of receipt for each of the plurality of responses into the storage device; and
querying the storage device for trends based on the plurality of responses.

2. The method of claim 1, wherein the electronic message requests information based on:
a psychometric assessment;
post operative monitoring;
treatment compliance; or
pharmaceutical compliance.

3. The method of claim 1, further comprising:
transmitting an emergency electronic message if the plurality of responses meets or exceeds a specified criteria for a predefined duration or a predefined severity.

4. The method of claim 1, further comprising:
tracking a treatment recommendation;
generating an electronic prescription; or
generating a patient information handout.

5. The method of claim 1, further comprising:
generating using the storage device, a record of trends, over a time period comprising one of:
daily, weekly, monthly or yearly.

6. The method of claim 1, further comprising:
storing into the storage device, service provider data associated with the patient.

7. The method of claim 6, wherein service provider data comprises:
prescription information, treatment recommendations, or patient compliance with a pharmaceutical regime.

8. The method of claim 1, further comprising:
Providing to a person designated by the patient a graphical display of a plurality of patient responses over an adjustable range of time periods.

9. The method of claim 1, wherein the electronic message comprises a request for information on:
mental or physical phenomena comprising: depression, mania, anxiety, pain, sleep quality, sleep quantity, sexual function, dizziness, weakness, concentration, memory, appetite, daily calories, bowel function, bladder function, exercise capacity, exercise quantity, or compliance with a pharmaceutical regime.

10. The method of claim 1, wherein the received plurality of responses comprises:
a psychometric scale of interest of the patient comprising:
depression, mania, anxiety, pain, sleep quality, sleep quantity, sexual function, dizziness, weakness, concentration, memory, appetite, daily calories, bowel function, bladder function, exercise capacity or exercise quantity; or
information on patient compliance with a pharmaceutical regime.

11. The method of claim 1, wherein each of the received plurality of responses comprises a single numeric response.

12. The method of claim 1, wherein the transmitting comprises transmitting the electronic message by a mobile phone, a personal digital assistant, a computer, a pager, a voice mail account, or an email account.

13. The method of claim 1, wherein the transmitting comprises transmitting the electronic message hourly, daily, weekly, monthly or yearly.

14. The method of claim 1, wherein the patient contact information comprises:
a telephone number;
an email address; or
an Internet Protocol address (IP address).

15. The method of claim 1, wherein the querying the storage device comprises a query using a computer.

16. A computer readable medium storing executable instructions for execution by a computer having memory, the medium storing instructions for:
inputting contact information into a data storage device;
transmitting an electronic message based on the contact information;
receiving a response;
storing the response and a timestamp into the data storage device;
storing a time and date of receipt of the response into the data storage device; and
querying the database for trends based on the response.

17. The computer readable medium of claim 15, wherein the electronic message requests information based on:
a psychometric assessment;
post operative monitoring;
treatment compliance; or
pharmaceutical compliance.

18. The computer readable medium of claim 15, further comprising instructions for:
transmitting an emergency electronic message if the plurality of responses meets or exceeds a specified criterion for a predefined duration or a predefined severity.

19. A patient monitoring system comprising:
a data storage device;
a messaging system coupled to the data storage device; and
a central processing unit (CPU) having memory storing CPU-executable instructions for assisting with a psychometric assessment of a patient, wherein the CPU is coupled to the messaging system and the data storage device; and the CPU performs the following according to the CPU-executable instructions:
storing a patient contact information in the data storage device;
transmitting an electronic message based on the contact information;
receiving a response;
storing the response in the data storage device; and
storing a time and date of receipt of the response into the data storage device.

20. The patient monitoring system of claim 18, wherein the electronic message requests information based on:
a psychometric assessment;
post operative monitoring;
treatment compliance; or
pharmaceutical compliance.

21. The patient monitoring system of claim 18, wherein the CPU-executable instructions further comprise:
transmitting an emergency electronic message if the plurality of responses meets or exceeds a specified criterion for a predefined duration or a predefined severity.
